(19) United States
(12) Patent Application Publication
(10) Pub. No.: US 2015/0054632 A1
(43) Pub. Date: Feb. 26, 2015

(54) SPORTS BALL HAVING SENSOR AND COMMUNICATION CAPABILITIES

(71) Applicant: Ariel Ben Ezra, New York, NY (US)

(72) Inventor: Ariel Ben Ezra, New York, NY (US)

(21) Appl. No.: 14/313,580

(22) Filed: Jun. 24, 2014

Related U.S. Application Data
(60) Provisional application No. 61/839,230, filed on Jun. 25, 2013.

(51) Int. Cl. G08C 17/02; G06F 17/18

(52) U.S. Cl. CPC G08C 17/02; G06F 17/18
USPC 340/323 R

(57) ABSTRACT

A system architecture for transmitting game data to users. The system uses sensors embedded on player's equipment and transmits data from sensors to a computer. The computer calculates statistics based on data in receives from the sensors and transmits calculated information to a computer or mobile device.

### RELATED APPLICATIONS

This application claims the benefit of pending U.S. Prov. Pat. Appl. Ser. No. 61/839,230 filed Jun. 25, 2013—the contents of which are incorporated by reference herein.

### FIELD OF THE INVENTION

The current invention relates to the field of sports balls, more specifically to a ball having electronic sensors which communicate through a wireless network.

### BACKGROUND OF THE INVENTION

Sports played using a sports ball is extremely popular across the globe. With the advances of technology and media, statistics and other analyses have become an integral part of the game.

### SUMMARY OF THE INVENTION

The invention set forth herein is a sports ball that is equipped with one or more sensors, which feed sensed information through a network. The sensors detect different properties associated with game play and transmit the information to computers for display to users.

### BRIEF DESCRIPTION OF THE DRAWINGS

FIG. 1 is a schematic view of system architecture according to an embodiment of the invention.

FIG. 2 is a front view of a hockey player equipped with sensors according to an embodiment of the invention.

### DETAILED DESCRIPTION OF THE INVENTION

Embodiments of the present invention will now be described with reference to the above-identified figures. However, the drawings and the description herein of the invention are not intended to limit the scope of the invention. It will be understood that various modifications of the present description of the invention are possible without departing from the spirit of the invention. Also, features or steps described herein may be omitted, additional steps or features may be included, and/or features or steps described herein may be combined in a manner different from the specific combinations recited herein without departing from the spirit of the invention, all as understood by those of skill in the art.

The invention set forth herein is a system architecture whereby sensors and/or communicators embedded in or provided on sports players or sports equipment transmit data via a network to computers or to user devices. For example, sensor may be placed on sports equipment to independently transmit data or sensor on sports equipment may communicate with one or more communicators worn by a player or embedded in the players clothing, protective gear or other accessories. The data that is transmitted may include real-life statistics such as speed of a ball/puck, speed of a player, duration of time that a player is in contact with a ball/puck and such similar information.

In one embodiment of the invention, a computer is used to calculate statistic from data received from sensors, control operations, execute routines and store data in digital memory and it may comprise at least one or more processors and memory storage devices. The computer also may receive a number of inputs and outputs for communicating information externally. The computer operates under the control of an operating system and software applications, components and programs that execute the routines and systems described herein. In general, the routines executed to implement the embodiments of the invention, whether implemented as part of an operating system or a specific application, component, program, object, module or sequence of instructions will be referred to herein as “the system,” “software” or as the “computer.”

The ball of the current invention is provided with one or more sensors within the inside lumen of the ball or on the surface thereof. For example, the sensor may be positioned in the center of the ball or placed at equidistant points around the inside surface of the ball to ensure uniform distribution of weight. Sensors may include motion sensors, pressure sensors and the like. The sensors send output measurements to end user computers via a wireless network.

Additionally or alternatively, the ball may be provided with an accelerometer to detect motion and location of the ball and communicate the same to end users via a wireless network. Single or multi-axis models of accelerometers may be used in different embodiments of the invention. In one embodiment, the accelerometer detects magnitude and direction of the proper acceleration (or g-force), as a vector quantity, and can be used to sense orientation (because direction of weight changes), coordinate acceleration (so long as it produces g-force or a change in g-force), vibration, and shock.

In addition, the inventive ball may communicate with accessories worn on players. For example, a soccer player may wear a “communicator band” on his/her lower leg or it may be embedded in his/her shoe or sock. The communicator detects a presence of a soccer ball when it comes in close proximity to the communicator. (A “communicator” herein refers to an electronic device that may detect the presence of a second device such as a sensor and send electronic data to a computer or server based on such detection).

In one embodiment of the invention, the communicator worn by a player comprises an RFID tag and an RFID reader is provided in the ball. In other embodiments, the player wears an RFID reader, which reads a tag provided in a ball. The tag/reader is optimized to recognize one another when the tag and reader are in very close proximity (e.g. within 8″ to 1′). This allows for communication between ball and player when a player is handling/dribbling the ball. It will be understood that any of various wireless communication means may be utilized in different embodiments of the invention. In one example, Bluetooth® communication is utilized.

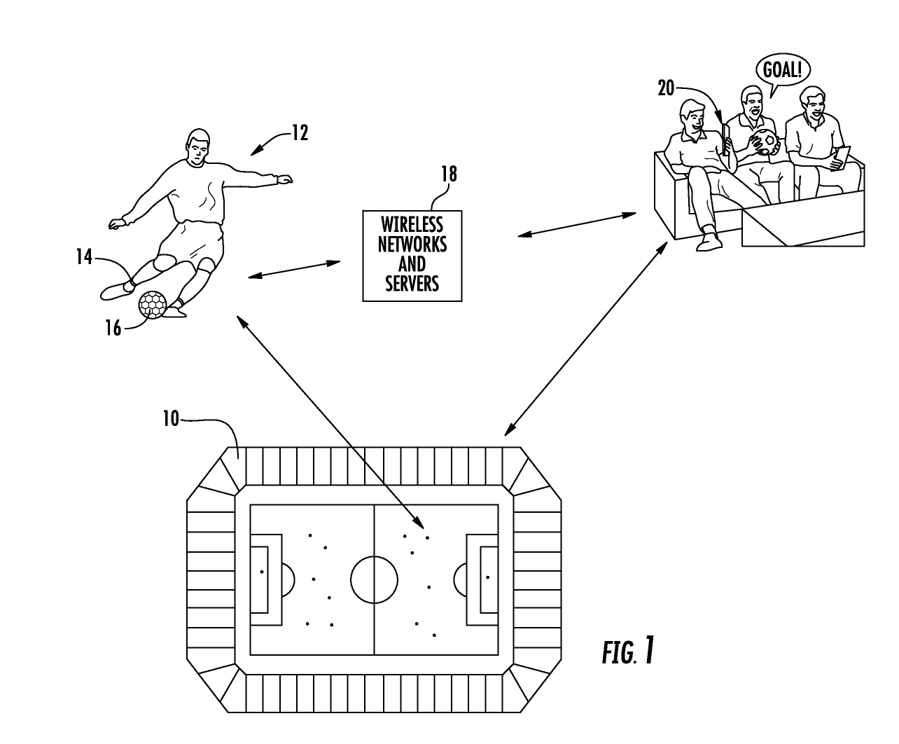

FIG. 1 shows a schematic diagram of a platform for transmitting data to end users according to an embodiment of the invention. A playing field 10 (soccer field in the present embodiment) is schematically shown having multiple players. An enlarged view of a player 12 is shown. Player 12 is wearing a communicator device 14 on his ankle. The communicator initiates electronic communication with ball 16 when it comes in close enough proximity thereto.

Information from the communicator/ball and other output signals are transmitted via a wireless network 18 to end user computers and/or mobile devices 20. The end users are, as such, provided with augmented and enhanced information about intricate aspects of the game.

The sport ball of the invention, as such, can compute the different stages of the ball and/or kick and movement. Sensors provided in a baseball or softball may determine if a ball thrown is a four seam fast ball, two seam fast ball, cutler, splinter, forkball, slurve, screwball, change up, palm ball, circle change up act and the like.

The inventive sports ball and cooperating accessories can record analyze and display information on the players such as how long they are walking, jogging running, sprinting, jumping, walking backwards and the percentage rate.

For example, based on how long a communicator of a particular player is connected (via electronic signal) to a ball—a timer may determine how much time that player had possession of the ball for a particular play. All of the times that that player had possession of the ball may be tallied to determine overall time and percentages. Moreover, time may be calculated from the time a ball leaves the possession of one player and enters the possession of another player. The speed of the ball may be calculated in this manner.

Sports ball and accessory can record the speed of the ball, velocity, acceleration, distance, heights, angles, control of the ball by the different players and different teams, and display the information on a computer, TV, phone, tablet and or computer generated application. A user who receives such information, may in turn share such information with friends via social media networks or store the information for future reference.

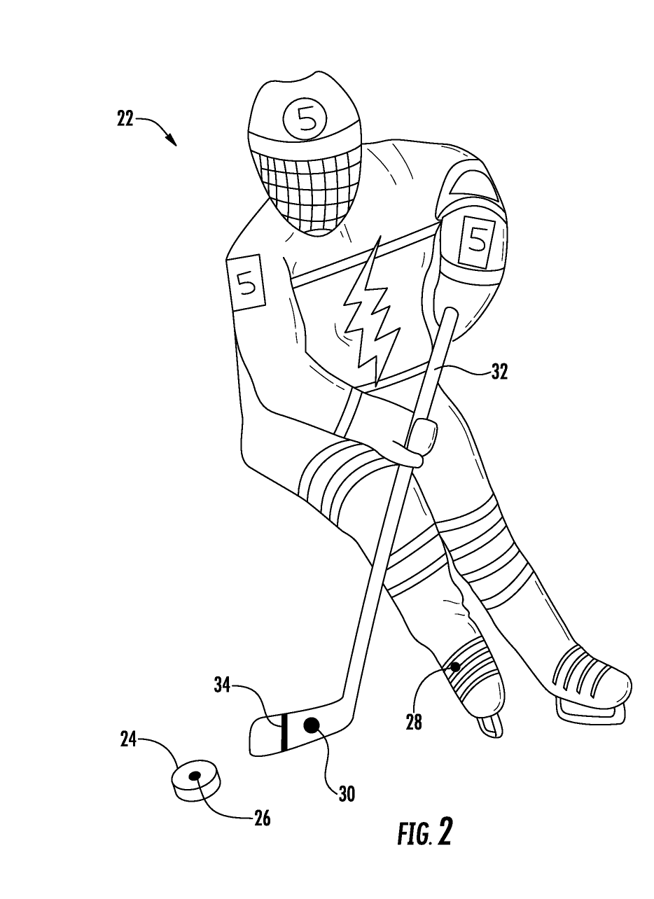

FIG. 2 shows an embodiment of the invention where the inventive system architecture is used to transmit data during a hockey game. One or more sensors are provided on the hockey player's protective equipment and still more sensors may be provided in or on the puck. In one embodiment of the invention, a puck 24 provided with one or more sensors 26 communicates with one or more accessories worn on the player 22. For example, the player may wear a “communicator band” on his/her lower leg (as described above) or a communicator 28 may be embedded in his/her skate or sock. The communicator detects a presence of a puck 24 when it comes in close proximity to the communicator. In one embodiment, one or more sensors 30 are mounted to the hockey stick 32. In one embodiment, a motion sensor on the hockey stick detects the distance of the stick movement. A speed sensor may determine the speed at which the stick is swung.

In one embodiment of the invention, a communicator 34 is mounted on a hockey stick which comprises an RFID tag and an RFID reader is provided in or on the puck 24. In other embodiments, the player wears an RFID reader, which reads a tag provided in or on the puck 24. The tag/reader is optimized to recognize one another when the tag and reader are in very close proximity (e.g. within 1″ to 8′). This allows for communication between puck and player when a player is handling the puck 24. It will be understood that any of various wireless communication means may be utilized in different embodiments of the invention. In one example, Bluetooth® communication is utilized.

As will be understood by those of ordinary skill in the art various types of data may be transmitted from the communicator and/or sensors via a computer network to provide various game statistics. For example, a computer system may measure a duration of communication between a communicator and sensor. Based on how long a communicator of a particular player is connected (via electronic signal) to a puck—a timer may determine how much time that player had possession of the puck for a particular play. All of the times that that player had possession of the puck may be tallied to determine overall time and percentages. Moreover, time may be calculated from the time a puck leaves the possession of one player and enters the possession of another player. The speed of the ball may be calculated in this manner.

Sports ball and accessory may stream live TV in real time of and/or video replays of the game different stages, commentaries, announcements by the reporters and or different people, TV , team songs, statists and analysis of the game, penalties different stages of the game such as touch down, goal; dunk can be transmitted through an email text , computer generated graphics and/or video, live to the fans in the arena, stadium, and venue using wireless technology methods in real time at the game with other devices such as servers and or networks.

Smartphone tablet, personal digital assistant (PDA), or other digital mobile devices may allow the fans at the game to send and/or receive communications such as telephone calls, emails, SMS messages, social network updates and posting on different social networking sites etc. and communicate with other devices such as servers and or networks.

In an example embodiment of the present disclosure the ball and sports accessory may be Energy harvested, Rechargble battery and/or, for example, a direct electric connection. The sports ball and sports may include Plastic electronics such as printed memory, organic sensors, flexible batteries, smart objects (protection and gear) and smart textiles.

Having described this invention with regard to specific embodiments, it is to be understood that the description is not meant as a limitation since further modifications and variations may be apparent or may suggest themselves to those skilled in the art. It is intended that the present application cover all such modifications and variations.

What is claimed is:

1. A system for transmitting game data, comprising;
a communicator provided on a player;
a sensor provided on a an article of sports equipment;
a computer network, said computer network receiving data from said sensor or said communicator, whereby said computer network transmits said data to a computer or mobile device.

2. The system of claim 1, whereby said communicator comprises a device for communicating via RFID signals.

3. The system of claim 1, whereby said communicator comprises a device for communicating via Bluetooth technology.

4. The system of claim 1, whereby said sensor is provided on a ball or puck.

5. The system of claim 1, whereby said communicator is a wearable band worn by a player.

6. The system of claim 1, whereby said computer network comprises computer for receiving information from said sensors, whereby said computer calculates statistics based on information received from said sensors.
